(19) United States
(12) Patent Application Publication
(10) Pub. No.: US 2026/0190102 A1
(43) Pub. Date: Jul. 2, 2026

(54) COMMUNICATION METHOD, ELECTRONIC DEVICE, AND STORAGE MEDIUM

(71) Applicant: Beijing Xiaomi Mobile Software Co., Ltd., Beijing (CN)

(72) Inventor: Xiandong DONG, Beijing (CN)

(73) Assignee: Beijing Xiaomi Mobile Software Co., Ltd., Beijing (CN)

(21) Appl. No.: 19/130,016

(22) PCT Filed: Nov. 14, 2022
(86) PCT No.: PCT/CN2022/131747

§ 371 Date: May 14, 2025

(51) Int. Cl. H04W 72/0457; H04L 1/00; H04L 27/26; H04W 74/0816

(52) U.S. Cl. CPC H04W 72/0457; H04L 1/0003; H04L 27/2603; H04W 74/0816

(57) ABSTRACT

A communication method and system for wireless transmission using aggregated physical layer protocol data units (A-PPDUs). An access point (AP) determines an A-PPDU comprising one or more sub-PPDUs, where each sub-PPDU includes a physical layer preamble containing bandwidth information indicating the transmission bandwidth of that sub-PPDU. The bandwidth information may be embedded in a legacy signal (L-SIG) field along with a legacy length (L-length) subfield providing sub-PPDU length. Additional signal (SIG) fields of each sub-PPDU may carry further information including basic service set (BSS) color, station identifiers, modulation and coding scheme (MCS), uplink/downlink identifiers, transmission opportunity (TXOP) values, and padding data. Media Access Control (MAC) fields include receiver and transmitter addresses, which vary depending on whether the A-PPDU is for uplink or downlink transmission, and support multi-link devices (MLDs). Implementations include electronic devices and computer-readable media configured to perform these communication methods for enhanced multi-user and multi-link wireless communication.

### CROSS REFERENCE TO RELATED APPLICATIONS

This application is a US National Phase of a PCT Application No. PCT/CN2022/131747 filed on Nov. 14, 2022, the entire contents of which are incorporated herein by reference in their entirety.

### TECHNICAL FIELD

The embodiments of the present disclosure relate to the field of mobile communication technology, in particular to communication methods, electronic devices, and storage media.

### BACKGROUND

With the rapid development of mobile communication technology, Wireless Fidelity (Wi-Fi) technology has made tremendous progress in transmission speed and throughput. At present, in Wi-Fi technology, topics such as Ultra High Reliability (UHR) is researched, with the vision of improving the reliability of Wireless Local Area Networks (WLAN) connectivity, reducing latencies, increasing manageability, increasing throughput at different Signal to Noise Ratio (SNR) levels, and reducing device level power consumption. Moreover, in UHR, in order to improve the system throughput, a method of communicating simultaneously in the sub7 GHz (gigahertz) and 45 GHz and/or 60 GHz frequency bands is proposed.

In order to improve the throughput of the system, it may be possible to support large bandwidth communication, such as 320 MHz or 640 MHz, on the device side of the Access Point Multi-Link Device (AP MLD). The Station (STA) device only supports small bandwidth communication, such as 160 MHz or 80 MHz. In this case, in order to maximize the utilization of AP capabilities, an Aggregated Physical Layer Protocol Data Unit (A-PPDU) can be transmitted. Therefore, it is necessary to provide an A-PPDU frame format to achieve UHR.

### SUMMARY

The embodiments of the present disclosure provide communication methods, electronic devices, and storage media for providing A-PPDU frame formats.

On the one hand, the embodiments of the present disclosure provide a communication method performed by an access point device, including:
determining an Aggregated Physical Layer Protocol Data Unit (A-PPDU); where the A-PPDU includes one or more sub-PPDUs, and for each of the one or more sub-PPDUs, a physical layer preamble of the sub-PPDU includes bandwidth information, where the bandwidth information indicates a transmission bandwidth of the sub-PPDU; and transmitting the A-PPDU.

On the other hand, the embodiments of the present disclosure further provide a communication method performed by a station device, including:
receiving a target sub-PPDU in an Aggregated Physical Layer Protocol Data Unit (A-PPDU);
where the A-PPDU includes one or more sub-PPDUs, and for each of the one or more sub-PPDUs, a physical layer preamble of the sub-PPDUs includes bandwidth information, where the bandwidth information indicates a transmission bandwidth of the sub-PPDU.

On the other hand, the embodiments of the present disclosure further provide an electronic device, which is an access point device, including:
a determining module, configured to determine an Aggregated Physical Layer Protocol Data Unit (A-PPDU); where the A-PPDU includes one or more sub-PPDUs, and for each of the one or more sub-PPDUs, a physical layer preamble of the sub-PPDU includes bandwidth information, where the bandwidth information indicates a transmission bandwidth of the sub-PPDU; and
a transmitting module, configured to transmit the A-PPDU.

On the other hand, the embodiments of the present disclosure further provide an electronic device, which is a station device, including:
a receiving module, configured to receive a target sub-PPDU in an Aggregated Physical Layer Protocol Data Unit (A-PPDU);
where the A-PPDU includes one or more sub-PPDUs, and for each of the one or more sub-PPDUs, a physical layer preamble of the sub-PPDUs includes bandwidth information, where the bandwidth information indicates a transmission bandwidth of the sub-PPDU.

The embodiments of the present disclosure further provide an electronic device including a memory, a processor, and a computer program stored on the memory and executable on the processor. The processor executes the program, to implement the method described in one or more of the embodiments of the present disclosure.

The embodiments of the present disclosure further provide a computer-readable storage medium on which a computer program is stored. The computer program is executed by a processor, to implement the method described in one or more of the embodiments of the present disclosure.

In the embodiments of the present disclosure, the AP determines the Aggregated Physical Layer Protocol Data Unit (A-PPDU); where the A-PPDU includes one or more sub-PPDUs, and for each of the one or more sub-PPDUs, a physical layer preamble of the sub-PPDU includes bandwidth information, where the bandwidth information indicates a transmission bandwidth of the sub-PPDU; and the A-PPDU is transmitted, so as to standardize the format of the A-PPDU, improve system throughput, and make it suitable for UHR requirements.

The additional aspects and advantages of the embodiments of the present disclosure will be partially presented in the following description, which will become apparent from the following description or learned through practice of the present disclosure.

### BRIEF DESCRIPTION OF DRAWINGS

In order to more clearly illustrate the technical solutions according to the embodiments of the present disclosure, drawings that need to be used in the description of the embodiments will be briefly introduced below. The drawings in the following description only relate to some embodiments of the present disclosure. For those skilled in the art, other drawings can also be obtained according to these drawings without creative effort.

FIG. 1 is the first flowchart of a communication method provided in the embodiments of the present disclosure.

FIG. 2 is the first schematic diagram of the first example of the embodiments of the present disclosure.

FIG. 3 is the second schematic diagram of the first example of the embodiments of the present disclosure.

FIG. 4 is a schematic diagram of the second example of the embodiments of the present disclosure.

FIG. 5 is a schematic diagram of the third example of the embodiments of the present disclosure.

FIG. 6 is the second flowchart of the communication method provided in the embodiments of the present disclosure.

FIG. 7 is the first schematic structural diagram of an electronic device provided in the embodiments of the present disclosure.

FIG. 8 is the second schematic structural diagram of an electronic device provided in the embodiments of the present disclosure.

FIG. 9 is the third schematic structural diagram of an electronic device provided in the embodiments of the present disclosure.

### DETAILED DESCRIPTION

Embodiments will be described in detail here with the examples thereof expressed in the drawings. Where the following description refers to the drawings, elements with the same numerals in different drawings refer to the same or similar elements unless otherwise indicated. Implementations described in the following embodiments do not represent all implementations consistent with the present disclosure. On the contrary, they are examples of an apparatus and a method consistent with some aspects of the present disclosure described in detail in the appended claims.

The term used in the embodiments of the present disclosure is for the purpose of describing particular examples only and is not intended to limit the present disclosure. As used in the present disclosure and the appended claims, the singular forms “a,” “an” and “the” are intended to include the plural forms as well, unless the context clearly indicates otherwise. It should further be understood that the term “and/or” as used herein refers to and includes any and all possible combinations of one or more of the items listed in the associated list. For example, A and/or B can represent three situations of A alone, A and B simultaneously, and B alone. The character “/” generally indicates that the associated objects before and after “/” are in an “or” relationship. The term ‘a plurality of’ refers to two or more, and therefore, in the embodiments of the present disclosure, ‘a plurality of’can also be understood as ‘at least two’.

It should be understood that although the terms first, second, third, etc. may be used in the present disclosure to describe various information, such information should not be limited to these terms. These terms are only used to distinguish the same type of information from each other. For example, without departing from the scope of the present disclosure, the first information may also be referred to as the second information, and similarly, the second information may also be referred to as the first information. Depending on the context, the word “if” as used herein can be interpreted as “at the time of,” “when” or “in response to determining”.

The technical solutions in the embodiments of the present disclosure are clearly described below with reference to the accompanying drawings in the embodiments of the present disclosure. The embodiments described are merely some embodiments of the present disclosure, and not all embodiments. Other embodiments achieved by those skilled in the art according to the embodiments in the present disclosure without paying creative work shall all fall within the scope of protection of the present disclosure.

The embodiments of the present disclosure provide communication methods, electronic devices, and storage media for providing A-PPDU frame formats.

Where the methods and apparatuses are based on the same application concept. Since the problem-solving principles of the methods and apparatuses are similar, the implementation of the apparatuses and the implementation of methods can be referred to each other, which will not be repeated.

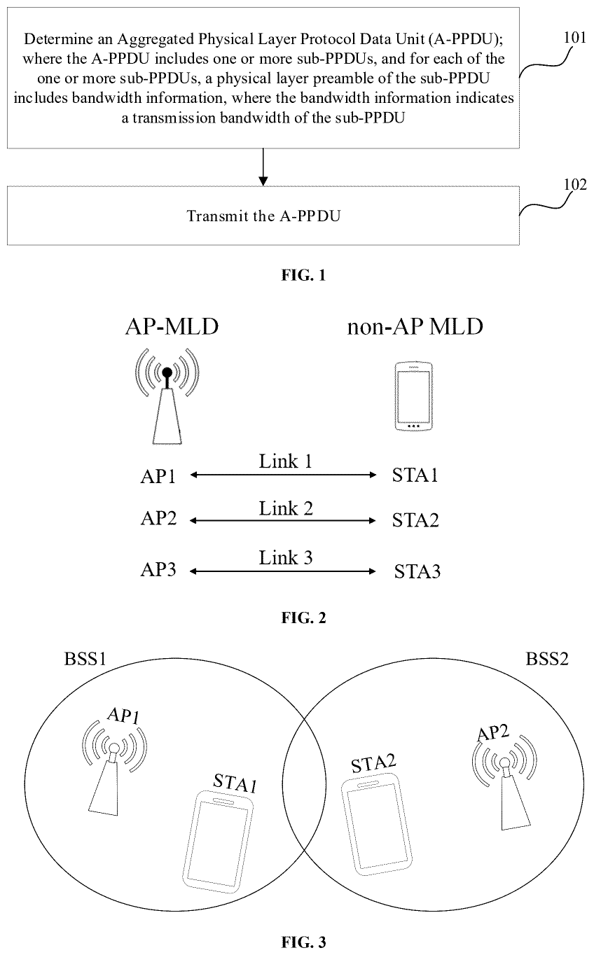

As shown in FIG. 1, the embodiments of the present disclosure provide a communication method, which can be optionally performed by an access point (AP) device. In some embodiments of the present disclosure, the AP, such as a device with wireless to wired bridging function, is responsible for extending the services provided by the wired network to the wireless network; The Station device (STA), such as an electronic device with wireless network access function, provides frame delivery services to facilitate the transmission of information.

The method may include the following steps 101 and 102.

In step 101, an Aggregated Physical Layer Protocol Data Unit (A-PPDU) is determined; where the A-PPDU includes one or more sub-PPDUs, and for each of the one or more sub-PPDUs, a physical layer preamble of the sub-PPDU includes bandwidth information, where the bandwidth information indicates a transmission bandwidth of the sub-PPDU.

In a wireless local area network, a Basic Service Set (BSS) can consist of an AP and one or more stations (STAs) communicating with the AP. A basic service set can be connected to a Distribution System (DS) through the AP of the basic service set, and then connected to another basic service set to form an Extended Service Set (ESS).

Optionally, in the embodiments of the present disclosure, the AP and the STA can be devices that support multi-link connections. For example, the AP and the STA can be represented respectively as AP MLD and non-AP MLD. For ease of description, in the following text, an example of communication between one AP and one STA under multi-link connections will be mainly described, which is not limited in the embodiments of the present disclosure.

As a first example, referring to FIGS. 2 and 3, the AP MLD can represent the access point that supports a multi-link communication function, and the non-AP MLD can represent the station that supports a multi-link communication function. In FIG. 3, AP1 and STA1 form BSS1, and AP2 and STA2 form BSS2.

Referring to FIG. 2, AP MLD can include three affiliated APs, AP1, AP2, and AP3 shown in FIG. 2. The APs can operate respectively on Link 1, Link 2, and Link 3. Non-AP MLD can also include three affiliated STAs, STA1, STA2, and STA3 shown in FIG. 2. STA1 works on Link 1, STA2 works on Link 2, and STA3 works on Link 3. In the example of FIG. 2, assuming that AP1 and STA1 communicate through the corresponding first link Link 1, similarly, AP2 and STA2 communicate through the corresponding second link Link 2, and AP3 communicates with STA3 through the third link Link 3. In addition, Link 1 to Link 3 can be links at different frequencies, such as links at 2.4 GHz, 5 GHZ, 6 GHZ, or can be several links with the same or different bandwidths at 2.4 GHz. In addition, there can be multiple channels under each link. It can be understood that the communication scenario shown in FIG. 2 is only exemplary, and the concept of the present disclosure is not limited to this. For example, an AP MLD can be connected to multiple (three) non-AP MLDs, or at each link, the AP can communicate with multiple other types of stations.

Normally, the maximum operating bandwidths of an AP and an STA that has an established link with the AP can support are different. For example, APs may support a maximum operating bandwidth of 320 MHz or 640 MHz, and STAs may only support a maximum operating bandwidth of 160 MHz or 80 MHz, or even smaller. In this case, in order to maximize the utilization of AP MLD capabilities and improve system throughput, A-PPDU can be transmitted.

In the embodiments of the present disclosure, the AP determines A-PPDU; where the A-PPDU includes one or more sub-PPDUs, and each sub-PPDU includes a physical layer preamble (PLCP Header preamble); where the physical layer preamble includes bandwidth information indicating the transmission bandwidth of the sub-PPDU; where A-PPDU includes one or more sub-PPDUs, each sub-PPDU may have a different bandwidth, equivalent to A-PPDU as a combination of sub-PPDUs, and for each sub-PPDU in the PPDU combination, the bandwidth information of the sub-PPDU in the PPDU combination indicates the bandwidth of the sub-PPDU in the PPDU combination. Where the sum of the transmission bandwidths of all sub-PPDUs is not greater than the transmission bandwidth of the A-PPDU. For example, the transmission bandwidth of A-PPDU is 320 MHz, sub-PPDU 1 is 80 MHz, sub-PPDU 2 is 80 MHz, and sub-PPDU 3 is 160 MHz, such that the sum of the bandwidths of the three sub-PPDUs is the transmission bandwidth of A-PPDU.

In step 102, the A-PPDU is transmitted.

Optionally, the AP can transmit the A-PPDU in the 6 GHz frequency band, and each sub-PPDU can be allocated to a station device, such as allocating a sub-PPDU to each STA, where the bandwidth of the allocated sub-PPDU is greater than or equal to the maximum operating bandwidth of the corresponding STA.

As a second example, as shown in FIG. 4, A-PPDU includes three sub-PPDUs, where PPDU-1 has a bandwidth of 160 MHz and the receiving end for the PPDU-1 can be STA 1, PPDU-2 has a bandwidth of 80 MHz and the receiving end for the PPDU-2 can be STA2, and PPDU-3 has a bandwidth of 80 MHz and the receiving end for the PPDU-3 can be STA3; the bandwidth information can separately identify the bandwidth information of three sub-PPDUs, and also identify the receiving end for different sub-PPDUs as different STAs. Optionally, the AID (association identifier) of the STA can be used as the identifier.

In the embodiments of the present disclosure, the AP determines the Aggregated Physical Layer Protocol Data Unit (A-PPDU); where the A-PPDU includes one or more sub-PPDUs, and for each of the one or more sub-PPDUs, a physical layer preamble of the sub-PPDU includes bandwidth information, where the bandwidth information indicates a transmission bandwidth of the sub-PPDU; and the A-PPDU is transmitted, so as to standardize the format of the A-PPDU, improve system throughput, and make it suitable for UHR requirements.

The embodiments of the present disclosure provide a communication method, which can be optionally performed by an access point (AP) device. The method may include the following steps:
determining an Aggregated Physical Layer Protocol Data Unit (A-PPDU); where the A-PPDU includes one or more sub-PPDUs, and for each of the one or more sub-PPDUs, a physical layer preamble of the sub-PPDU includes bandwidth information, where the bandwidth information is carried in the legacy signal (L-SIG) field of the physical layer preamble. The bandwidth information indicates the transmission bandwidth of the sub-PPDU; and transmitting the A-PPDU.

As a third example, refer to FIG. 5, which shows a schematic diagram of a sub-PPDU; where the sub-PPDU includes the physical layer preamble part, including the L-SIG field of the physical layer preamble part.

The L-SIG field includes the Legacy part signaling field, which is typically used to carry encoding rate and length information. The L-SIG field is based on a basic bandwidth of 20 MHz. For example, if the total bandwidth of A-PPDU is 320 MHz, the L-SIG field appears 16 times; and when the bandwidth is 40 MHz or 80 MHz, the data of the L-SIG field is obtained by replicating the 20 MHz-bandwidth data of the L-SIG field twice or four times in the frequency domain to expand it onto the increased sub-carriers.

The L-SIG field further includes a legacy length (L-length) subfield, where the L-length subfield includes length information of the sub-PPDU.

The embodiments of the present disclosure provide a communication method, which can be optionally performed by an access point (AP). The method may include the following steps:
determining an Aggregated Physical Layer Protocol Data Unit (A-PPDU); where the A-PPDU includes one or more sub-PPDUs, and for each of the one or more sub-PPDUs, a physical layer preamble of the sub-PPDU includes bandwidth information, where the bandwidth information indicates a transmission bandwidth of the sub-PPDU; and
transmitting the A-PPDU.

Referring to FIG. 5, FIG. 5 shows a schematic diagram of a sub-PPDU, which includes a SIG field. The SIG field of the sub-PPDU includes at least one of the following:
the basic service set (BSS) color information of the sub-PPDU; where the BSS color mechanism is used to allocate different “colors” to BSSs, which is the identifier of the AP, used by the STA to quickly identify whether the PPDU is transmitted by an associated BSS, so as to save device power; where the purpose of this mechanism is to increase the system capacity of wireless networks in dense environments, increase frequency reuse between BSSs, and reduce the MAC-layer contention overhead caused by overlapping BSSs;
the station device identifier corresponding to the sub-PPDU; where the station device identifier can be an Association Identifier (AID), usually allocated by the AP when the STA establishes an initial association with the AP; where the station device identifier can also be other identifiers used to uniquely identify station devices;
Modulation and Coding Scheme (MCS) information corresponding to the sub-PPDU; where Modulation and Coding Scheme (MCS) information refers to the information about the MCS approach, and the MCS approach includes the number of spatial streams, modulation methods, and transmission power, etc. For example, in the MCS modulation and coding table, each MCS serves as an index corresponding to a transmission power value (i.e., the second transmission power value); where the second transmission power value corresponding to the MCS varies in different frequency bands; and in different frequency bands, the MCS modulation and coding table has different contents;
uplink (UL) identifier information or downlink (DL) identifier information corresponding to the A-PPDU;
a Transmission Opportunity (TXOP) subfield, where the TXOP subfield includes length information of the sub-PPDU; or
a Padding Value subfield, where the Padding Value subfield includes Padding Value information of the sub-PPDU; where due to the possible inconsistency in the length of each sub-PPDU, to ensure the consistency of the length, a padding value subfield may be set in the SIG field of the PHY preamble of each sub-PPDU, to identify the padding value of each sub-PPDU, where the padding value may be 8 microseconds (us), 16 us, or 32 us.

The embodiments of the present disclosure provide a communication method, which can be optionally performed by an access point (AP). The method may include the following steps:
determining an Aggregated Physical Layer Protocol Data Unit (A-PPDU); where the A-PPDU includes one or more sub-PPDUs, and for each of the one or more sub-PPDUs, a physical layer preamble of the sub-PPDU includes bandwidth information, where the bandwidth information indicates a transmission bandwidth of the sub-PPDU; and transmitting the A-PPDU.

Where a Media Access Control (MAC) field of the sub-PPDU includes Receiver Address (RA) information and Transmission Address (TA) information.

When the A-PPDU is uplink data, the RA information includes the Media Access Control (MAC) address of the access point device, and the TA information includes the MAC address of the station device corresponding to the sub-PPDU. For example, when the uplink (UL) identifier information corresponding to the A-PPDU is set to 1, the RA address of all sub-PPDUs is the same and is the MAC address of the AP, and the TA is the MAC address of the STA corresponding to each sub-PPDU.

When the A-PPDU is downlink data, the RA information includes an MAC address of a station device corresponding to the sub-PPDU, and the TA information includes an MAC address of the access point device. For example, when the downlink (DL) identifier information corresponding to the A-PPDU is set to 1, the RA corresponding to each sub-PPDU is the MAC address of each STA, and the TA of all sub-PPDUs is the MAC address of the AP.

The embodiments of the present disclosure provide a communication method, which can be optionally performed by an access point (AP). The method may include the following steps:
determining an Aggregated Physical Layer Protocol Data Unit (A-PPDU); where the A-PPDU includes one or more sub-PPDUs, and for each of the one or more sub-PPDUs, a physical layer preamble of the sub-PPDU includes bandwidth information, where the bandwidth information indicates a transmission bandwidth of the sub-PPDU; and
transmitting the A-PPDU.

Where an MAC field of the sub-PPDU includes RA information and TA information.

The access point device is affiliated with an Access Point Multi-Link Device (AP MLD), and TA information of the access point device includes an MAC address of the AP MLD or an MAC address of a transmission link of the AP MLD;
and/or,
a station device is affiliated with a station Multi-Link Device (Non-AP MLD), and RA information of the station device includes an MAC address of a transmission link of the Non-AP MLD.

Where if the AP is affiliated with the MLD and the A-PPDU is downlink data, the TA can be the MAC address under the transmission link or the MAC address of the AP MLD; and if the STA is affiliated with a Non-AP MLD and the A-PPDU is downlink data, the RA information is the MAC address of the transmission link of the Non-AP MLD.

The embodiments of the present disclosure provide a communication method, which can be optionally performed by an access point (AP). The method may include the following steps:
determining an Aggregated Physical Layer Protocol Data Unit (A-PPDU); where the A-PPDU includes one or more sub-PPDUs, and for each of the one or more sub-PPDUs, a physical layer preamble of the sub-PPDU includes bandwidth information, where the bandwidth information indicates a transmission bandwidth of the sub-PPDU; where the physical layer preamble includes Legacy long training field (L-LTF) and Legacy short training field (L-STF); and
transmitting the A-PPDU.

Where referring to FIG. 5, the sub-PPDU includes L-STF (Legacy short training field, used for receiving data synchronization and coarse frequency offset estimation), L-LTF (Legacy long training field, used for fine frequency offset estimation and preamble channel estimation), L-SIG (legacy signal field, usually carrying encoding rate and length information), RL-STF (repeating legacy signal field), SIG (signaling field, used for carrying PPDU information), STF (Legacy short training field), LTF (Legacy short training field), Data (data field, used for carrying user data), and PE (Packet Extension, used to gain more processing time).

In the embodiments of the present disclosure, the AP determines the Aggregated Physical Layer Protocol Data Unit (A-PPDU); where the A-PPDU includes one or more sub-PPDUs, and for each of the one or more sub-PPDUs, a physical layer preamble of the sub-PPDU includes bandwidth information, where the bandwidth information indicates a transmission bandwidth of the sub-PPDU; and the A-PPDU is transmitted, so as to standardize the format of the A-PPDU, improve system throughput, and make it suitable for UHR requirements.

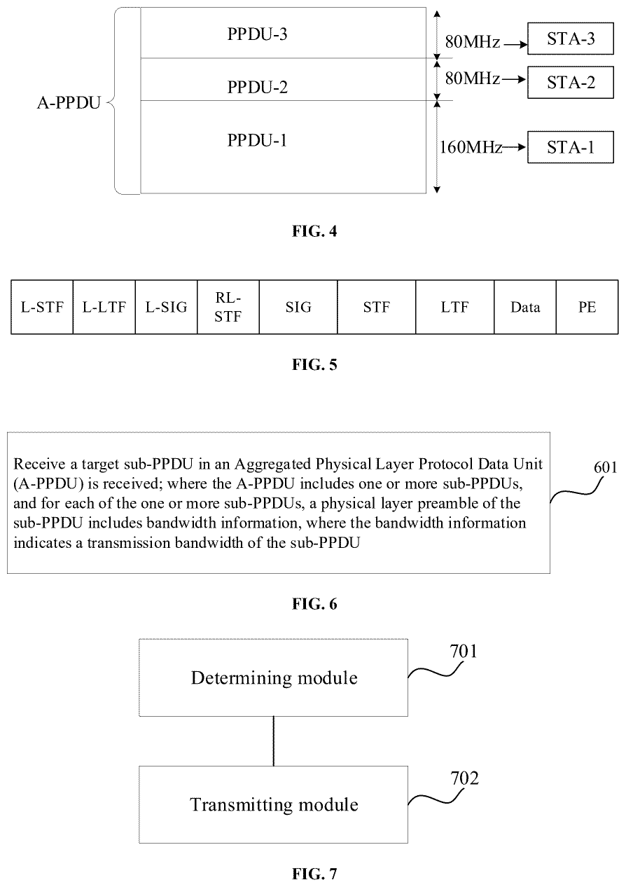

Referring to FIG. 6, the embodiments of the present disclosure provide a communication method, which can be optionally performed by a station device (STA), such as an electronic device with wireless network access function, provides frame delivery services to facilitate the transmission of information.

The method may include the following step 601.

In step 601, a target sub-PPDU in an Aggregated Physical Layer Protocol Data Unit (A-PPDU) is received.

Where the A-PPDU includes one or more sub-PPDUs, and for each of the one or more sub-PPDUs, a physical layer preamble of the sub-PPDU includes bandwidth information, where the bandwidth information indicates a transmission bandwidth of the sub-PPDU.

The architecture of the WLAN applied by the communication method provided in the embodiments of the present disclosure refers to the first example mentioned above and will not be repeated here.

Normally, the maximum operating bandwidths of an AP and an STA that has an established link with the AP can support are different. For example, APs may support a maximum operating bandwidth of 320 MHz or 640 MHz, and STAs may only support a maximum operating bandwidth of 160 MHz or 80 MHz, or even smaller. In this case, in order to maximize the utilization of AP MLD capabilities and improve system throughput, A-PPDU can be transmitted.

In the embodiments of the present disclosure, the STA receives A-PPDU; where the A-PPDU includes one or more sub-PPDUs, and each sub-PPDU includes a physical layer preamble (PLCP Header preamble); where the physical layer preamble includes bandwidth information indicating the transmission bandwidth of the sub-PPDU; where A-PPDU includes one or more sub-PPDUs, each sub-PPDU may have a different bandwidth, equivalent to A-PPDU as a combination of sub-PPDUs, and for each sub-PPDU in the PPDU combination, the bandwidth information of the sub-PPDU in the PPDU combination indicates the bandwidth of the sub-PPDU in the PPDU combination. Where the sum of the transmission bandwidths of all sub-PPDUs is not greater than the transmission bandwidth of the A-PPDU. For example, the transmission bandwidth of A-PPDU is 320 MHz, sub-PPDU 1 is 80 MHz, sub-PPDU 2 is 80 MHz, and sub-PPDU 3 is 160 MHz, such that the sum of the bandwidths of the three sub-PPDUs is the transmission bandwidth of A-PPDU.

Where the target sub-PPDU is allocated by the access point device to the station device. For example, a sub-PPDU is allocated to each STA, where the bandwidth of the allocated sub-PPDU is greater than or equal to the maximum operating bandwidth of the corresponding STA.

As a second example, as shown in FIG. 4, A-PPDU includes three sub-PPDUs, where PPDU-1 has a bandwidth of 160 MHz and the receiving end for the PPDU-1 can be STA1, PPDU-2 has a bandwidth of 80 MHz and the receiving end for the PPDU-2 can be STA2, and PPDU-3 has a bandwidth of 80 MHz and the receiving end for the PPDU-3 can be STA3; the bandwidth information can separately identify the bandwidth information of three sub-PPDUs, and also identify the receiving end for different sub-PPDUs as different STAs.

In the embodiments of the present disclosure, STA receives A-PPDU; where the A-PPDU includes one or more sub-PPDUs, and for each of the one or more sub-PPDUs, a physical layer preamble of the sub-PPDU includes bandwidth information, where the bandwidth information indicates a transmission bandwidth of the sub-PPDU. The embodiments of the present disclosure provide an A-PPDU format to improve system throughput and make it suitable for UHR requirements.

The embodiments of the present disclosure provide a communication method, which can be optionally performed by a station device. The method may include the following steps:
receiving a target sub-PPDU in an Aggregated Physical Layer Protocol Data Unit (A-PPDU);
Where the A-PPDU includes one or more sub-PPDUs, and for each of the one or more sub-PPDUs, a physical layer preamble of the sub-PPDU includes bandwidth information, where the bandwidth information indicates a transmission bandwidth of the sub-PPDU.

As a third example, refer to FIG. 5, which shows a schematic diagram of a sub-PPDU; where the sub-PPDU includes the physical layer preamble part, including the L-SIG field of the physical layer preamble part.

The L-SIG field includes the Legacy part signaling field, which is typically used to carry encoding rate and length information. The L-SIG field is based on a basic bandwidth of 20 MHz. For example, if the total bandwidth of A-PPDU is 320 MHz, the L-SIG field appears 16 times; and when the bandwidth is 40 MHz or 80 MHz, the data of the L-SIG field is obtained by replicating the 20 MHz-bandwidth data of the L-SIG field twice or four times in the frequency domain to expand it onto the increased sub-carriers.

The L-SIG field further includes a legacy length (L-length) subfield, where the L-length subfield includes length information of the sub-PPDU.

The embodiments of the present disclosure provide a communication method, which can be optionally performed by a station device. The method may include the following steps:
receiving a target sub-PPDU in an Aggregated Physical Layer Protocol Data Unit (A-PPDU);
Where the A-PPDU includes one or more sub-PPDUs, and for each of the one or more sub-PPDUs, a physical layer preamble of the sub-PPDU includes bandwidth information, where the bandwidth information indicates a transmission bandwidth of the sub-PPDU.

Referring to FIG. 5, FIG. 5 shows a schematic diagram of a sub-PPDU, which includes a SIG field. The SIG field of the sub-PPDU includes at least one of the following:
the basic service set (BSS) color information of the sub-PPDU; where the BSS color mechanism is used to allocate different “colors” to BSSs. where the purpose of this mechanism is to increase the system capacity of wireless networks in dense environments, increase frequency reuse between BSSs, and reduce the MAC-layer contention overhead caused by overlapping BSSs;
the station device identifier corresponding to the sub-PPDU; where the station device identifier can be an Association Identifier (AID), usually allocated by the AP when the STA establishes an initial association with the AP;
Modulation and Coding Scheme (MCS) information corresponding to the sub-PPDU; where Modulation and Coding Scheme (MCS) information refers to the information about the MCS approach, and the MCS approach includes the number of spatial streams, modulation methods, and transmission power, etc. For example, in the MCS modulation and coding table, each MCS serves as an index corresponding to a transmission power value (i.e., the second transmission power value); where the second transmission power value corresponding to the MCS varies in different frequency bands; and in different frequency bands, the MCS modulation and coding table has different contents;
uplink (UL) identifier information or downlink (DL) identifier information corresponding to the A-PPDU;
a Transmission Opportunity (TXOP) subfield, where the TXOP subfield includes length information of the sub-PPDU; or
a Padding Value subfield, where the Padding Value subfield includes Padding Value information of the sub-PPDU; where due to the possible inconsistency in the length of each sub-PPDU, to ensure the consistency of the length, a padding value subfield may be set in the SIG field of the PHY preamble of each sub-PPDU, to identify the padding value of each sub-PPDU, where the padding value may be 8 microseconds (us), 16 us, or 32 us.

The embodiments of the present disclosure provide a communication method, which can be optionally performed by a station device. The method may include the following steps:
receiving a target sub-PPDU in an Aggregated Physical Layer Protocol Data Unit (A-PPDU);
Where the A-PPDU includes one or more sub-PPDUs, and for each of the one or more sub-PPDUs, a physical layer preamble of the sub-PPDU includes bandwidth information, where the bandwidth information indicates a transmission bandwidth of the sub-PPDU. Where a Media Access Control (MAC) field of the sub-PPDU includes Receiver Address (RA) information and Transmission Address (TA) information.

When the A-PPDU is uplink data, the RA information includes the Media Access Control (MAC) address of the access point device, and the TA information includes the MAC address of the station device corresponding to the sub-PPDU. For example, when the uplink (UL) identifier information corresponding to the A-PPDU is set to 1, the RA address of all sub-PPDUs is the same and is the MAC address of the AP, and the TA is the MAC address of the STA corresponding to each sub-PPDU.

When the A-PPDU is downlink data, the RA information includes an MAC address of a station device corresponding to the sub-PPDU, and the TA information includes an MAC address of the access point device. For example, when the downlink (DL) identifier information corresponding to the A-PPDU is set to 1, the RA corresponding to each sub-PPDU is the MAC address of each STA, and the TA of all sub-PPDUs is the MAC address of the AP.

The embodiments of the present disclosure provide a communication method, which can be optionally performed by a station device. The method may include the following steps:
receiving a target sub-PPDU in an Aggregated Physical Layer Protocol Data Unit (A-PPDU);
Where the A-PPDU includes one or more sub-PPDUs, and for each of the one or more sub-PPDUs, a physical layer preamble of the sub-PPDU includes bandwidth information, where the bandwidth information indicates a transmission bandwidth of the sub-PPDU. The access point device is affiliated with an Access Point Multi-Link Device (AP MLD), and TA information of the access point device includes an MAC address of the AP MLD or an MAC address of a transmission link of the AP MLD;
and/or,
a station device is affiliated with a station Multi-Link Device (Non-AP MLD), and RA information of the station device includes an MAC address of a transmission link of the Non-AP MLD.

Where if the AP is affiliated with the MLD and the A-PPDU is downlink data, the TA can be the MAC address under the transmission link or the MAC address of the AP MLD; and if the STA is affiliated with a Non-AP MLD and the A-PPDU is downlink data, the RA information is the MAC address of the transmission link of the Non-AP MLD.

The embodiments of the present disclosure provide a communication method, which can be optionally performed by a station device. The method may include the following steps:
receiving a target sub-PPDU in an Aggregated Physical Layer Protocol Data Unit (A-PPDU);
Where referring to FIG. 5, the sub-PPDU includes L-STF (Legacy short training field, used for receiving data synchronization and coarse frequency offset estimation), L-LTF (Legacy long training field, used for fine frequency offset estimation and preamble channel estimation), L-SIG (legacy signal field, usually carrying encoding rate and length information), RL-STF (repeating legacy signal field), SIG (signaling field, used for carrying PPDU information), STF (Legacy short training field), LTF (Legacy short training field), Data (data field, used for carrying user data), and PE (Packet Extension, used to gain more processing time).

In the embodiments of the present disclosure, STA receives A-PPDU; where the A-PPDU includes one or more sub-PPDUs, and for each of the one or more sub-PPDUs, a physical layer preamble of the sub-PPDU includes bandwidth information, where the bandwidth information indicates a transmission bandwidth of the sub-PPDU. The embodiments of the present disclosure provide an A-PPDU format to improve system throughput and make it suitable for UHR requirements.

Referring to FIG. 7, based on the same principle as the method provided in the embodiments of the present disclosure, The embodiments of the present disclosure further provide an electronic device, which is an access point device, including:
a determining module 701, configured to determine an Aggregated Physical Layer Protocol Data Unit (A-PPDU); where the A-PPDU includes one or more sub-PPDUs, and for each of the one or more sub-PPDUs, a physical layer preamble of the sub-PPDU includes bandwidth information, where the bandwidth information indicates a transmission bandwidth of the sub-PPDU; and
a transmitting module 702, configured to transmit the A-PPDU.

In an optional embodiment, the bandwidth information is carried in a legacy signal (L-SIG) field of the physical layer preamble; and
The L-SIG field further includes a legacy length (L-length) subfield, where the L-length subfield includes length information of the sub-PPDU.

In an optional embodiment, the SIG field of the sub-PPDU includes at least one of the following:
basic service set (BSS) color information of the sub-PPDU;
a station device identifier corresponding to the sub-PPDU;
Modulation and Coding Scheme (MCS) information corresponding to the sub-PPDU;
uplink (UL) identifier information or downlink (DL) identifier information corresponding to the A-PPDU;
a Transmission Opportunity (TXOP) subfield, where the TXOP subfield includes length information of the sub-PPDU; or
a Padding Value subfield, where the Padding Value subfield includes Padding Value information of the sub-PPDU.

In an optional embodiment, a Media Access Control (MAC) field of the sub-PPDU includes Receiver Address (RA) information and Transmission Address (TA) information;
where when the A-PPDU is uplink data, the RA information includes an MAC address of the access point device, and the TA information includes an MAC address of a station device corresponding to the sub-PPDU;
where when the A-PPDU is downlink data, the RA information includes an MAC address of a station device corresponding to the sub-PPDU, and the TA information includes an MAC address of the access point device.

In an optional embodiment, the access point device is affiliated with an Access Point Multi-Link Device (AP MLD), and TA information of the access point device includes an MAC address of the AP MLD or an MAC address of a transmission link of the AP MLD;
and/or,
a station device is affiliated with a station Multi-Link Device (Non-AP MLD), and RA information of the station device includes an MAC address of a transmission link of the Non-AP MLD.

In an optional embodiment, the physical layer preamble includes a Legacy Long Training Field (L-LTF) and a Legacy Short Training Field (L-STF).

The embodiments of the present disclosure further provide a communication apparatus, applied to an access point device, including:
a PPDU determining module, configured to determine an Aggregated Physical Layer Protocol Data Unit (A-PPDU); where the A-PPDU includes one or more sub-PPDUs, and for each of the one or more sub-PPDUs, a physical layer preamble of the sub-PPDU includes bandwidth information, where the bandwidth information indicates a transmission bandwidth of the sub-PPDU; and
a PPDU transmitting module, configured to transmit the A-PPDU.

The apparatus further includes other modules of the electronic device in the previous embodiments, which will not be repeated here.

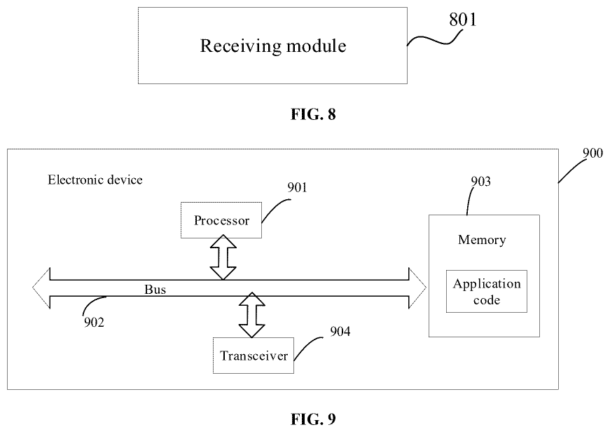

Referring to FIG. 8, based on the same principle as the method provided in the embodiments of the present disclosure, The embodiments of the present disclosure further provide an electronic device, which is an access point device, including:
a receiving module 801, configured to receive a target sub-PPDU in an Aggregated Physical Layer Protocol Data Unit (A-PPDU).

Where the A-PPDU includes one or more sub-PPDUs, and for each of the one or more sub-PPDUs, a physical layer preamble of the sub-PPDU includes bandwidth information, where the bandwidth information indicates a transmission bandwidth of the sub-PPDU.

In an optional embodiment, the bandwidth information is carried in a legacy signal (L-SIG) field of the physical layer preamble; and
The L-SIG field further includes a legacy length (L-length) subfield, where the L-length subfield includes length information of the sub-PPDU.

In an optional embodiment, the L-SIG field further includes at least one of the following:
basic service set (BSS) color information of the sub-PPDU;
a station device identifier corresponding to the sub-PPDU;
Modulation and Coding Scheme (MCS) information corresponding to the sub-PPDU;
uplink (UL) identifier information or downlink (DL) identifier information corresponding to the A-PPDU;
a Transmission Opportunity (TXOP) subfield, where the TXOP subfield includes length information of the sub-PPDU; or
a Padding Value subfield, where the Padding Value subfield includes Padding Value information of the sub-PPDU.

In an optional embodiment, a Media Access Control (MAC) field of the sub-PPDU includes Receiver Address (RA) information and Transmission Address (TA) information;
where when the A-PPDU is uplink data, the RA information includes an MAC address of the access point device, and the TA information includes an MAC address of a station device corresponding to the sub-PPDU;
where when the A-PPDU is downlink data, the RA information includes an MAC address of a station device corresponding to the sub-PPDU, and the TA information includes an MAC address of the access point device.

In an optional embodiment, the access point device is affiliated with an Access Point Multi-Link Device (AP MLD), and TA information of the access point device includes an MAC address of the AP MLD or an MAC address of a transmission link of the AP MLD;
and/or,
a station device is affiliated with a station Multi-Link Device (Non-AP MLD), and RA information of the station device includes an MAC address of a transmission link of the Non-AP MLD.

In an optional embodiment, the physical layer preamble includes a Legacy Long Training Field (L-LTF) and a Legacy Short Training Field (L-STF).

The embodiments of the present disclosure further provide a communication apparatus, applied to an access point device, including:
a PPDU receiving module, configured to receive a target sub-PPDU in an Aggregated Physical Layer Protocol Data Unit (A-PPDU).

Where the A-PPDU includes one or more sub-PPDUs, and for each of the one or more sub-PPDUs, a physical layer preamble of the sub-PPDU includes bandwidth information, where the bandwidth information indicates a transmission bandwidth of the sub-PPDU.

The apparatus further includes other modules of the electronic device in the previous embodiments, which will not be repeated here.

In an optional embodiment, the present disclosure further provides an electronic device, as shown in FIG. 9. The electronic device 900 shown in FIG. 9 can be a server, including a processor 901 and a memory 903. Where processor 901 is connected to memory 903, such as through bus 902. Optionally, electronic device 900 may also include a transceiver 904. It should be noted that in practical applications, the transceiver 904 is not limited to one, and the structure of the electronic device 900 does not constitute a limitation on The embodiments of the present disclosure.

The processor 901 can be a CPU (Central Processing Unit), general-purpose processor, DSP (Digital Signal Processor), ASIC (Application Specific Integrated Circuit), FPGA (Field Programmable Gate Array), or any combination thereof. It can implement or execute various exemplary logical blocks, modules, and circuits described in conjunction with the present disclosure. The processor 901 can also be a combination that implements computing functions, such as a combination containing one or more microprocessors, a combination of DSP and microprocessors, etc.

Bus 902 may include a pathway for transmitting information between the aforementioned components. Bus 902 can be a PCI (Peripheral Component Interconnect) bus or an EISA (Extended Industry Standard Architecture) bus, etc. Bus 902 can be divided into address bus, data bus, control bus, etc. For ease of representation, only one thick line is used in FIG. 9, but it does not indicate that there is only one bus or one type of bus.

The memory 903 can be a ROM (Read Only Memory) or other types of static storage devices that can store static information and instructions, or RAM (Random Access Memory) or other types of dynamic storage devices that can store information and instructions, can also be EEPROM (Electrically Erasable Programmable Read Only Memory), CD-ROM (Compact Disc Read Only Memory) or other optical disc storage, optical disc storage (including compressed optical discs, laser discs, optical discs, digital versatile discs, Blu ray discs, etc.), magnetic disk storage media or other magnetic storage devices, or any other medium that can be used to carry or store desired program code in the form of instructions or data structures and can be accessed by a computer, which is not limited.

The memory 903 is used to store the application program code for executing the disclosed scheme, and is controlled for execution by the processor 901. The processor 901 is used to execute the application program code stored in the memory 903 to implement the content shown in the aforementioned method embodiments.

Where electronic devices include but are not limited to mobile terminals such as mobile phones, laptops, digital broadcast receivers, PDAs (personal digital assistants), PADs (tablets), PMPs (portable multimedia players), car terminals (such as car navigation terminals), and fixed terminals such as digital TVs, desktop computers, and so on. The electronic device shown in FIG. 9 is only an example and should not impose any limitations on the scope of function and use of the embodiments of the present disclosure.

The servers provided in the present disclosure can be independent physical servers, server clusters or distributed systems composed of multiple physical servers, or cloud services, cloud databases, cloud computing, cloud functions, cloud storage, network services, cloud communication, middleware services, domain name services, security services, CDNs, or cloud servers for basic cloud computing services such as big data and artificial intelligence platforms. The terminal can be a smartphone, tablet, laptop, desktop computer, smart speaker, smartwatch, etc., which is not limited. Terminals and servers can be directly or indirectly connected through wired or wireless communication methods, which is not limited in the present disclosure.

The embodiments of the present disclosure provide a computer-readable storage medium on which a computer program is stored, which, when run on a computer, enables the computer to execute the corresponding content of the aforementioned method embodiments.

It should be understood that although the various steps in the flowchart of figures are displayed in sequence according to the arrows, these steps are not necessarily executed in sequence in the order indicated by the arrows. Unless otherwise specified in this article, there is no strict order limit for the execution of these steps, and they can be executed in other orders. Moreover, at least some of the steps in the flowchart of the attached figures may include multiple sub-steps or stages, which are not necessarily completed at the same time, but can be executed at different times. Their execution order is not necessarily sequential, but can be rotated or alternated with at least some of other steps or the sub-steps or stages of other steps.

It should be noted that the computer-readable medium mentioned in the present disclosure can be a computer-readable signal medium, a computer-readable storage medium, or any combination of the two. Computer readable storage media can be, for example but not limited to, systems, devices, or elements of electricity, magnetism, light, electromagnetism, infrared, or semiconductors, or any combination thereof. More specific examples of computer-readable storage media may include, but are not limited to, electrical links with one or more wires, portable computer disks, hard drives, random access memory (RAM), read-only memory (ROM), erasable programmable read-only memory (EPROM or flash memory), fiber optics, portable compact disk read-only memory (CD-ROM), optical storage devices, magnetic storage devices, or any suitable combination thereof. In the present disclosure, a computer-readable storage medium can be any tangible medium containing or storing a program that can be used by an instruction execution system, apparatus, or device, or used in combination with it. In the present disclosure, computer-readable signal media may include data signals propagated in the baseband or as part of a carrier wave, carrying computer-readable program code. This propagated data signal can take various forms, including but not limited to electromagnetic signals, optical signals, or any suitable combination thereof. Computer readable signal media can also be any computer-readable medium other than computer-readable storage media, which can transmit, propagate, or transmit programs for use by or in combination with instruction execution systems, devices, or equipment. The program code contained in a computer-readable medium can be transmitted using any suitable medium, including but not limited to wires, optical cables, RF (radio frequency), etc., or any suitable combination of the above.

The computer-readable medium mentioned above may be included in the electronic device mentioned above, and can also exist independently without being assembled into the electronic device.

The above-mentioned computer-readable medium carries one or more programs, which, when executed by the electronic device, cause the electronic device to perform the method shown in the above embodiments.

According to one aspect of the present disclosure, a computer program product or computer program, including computer instructions, is provided in a computer-readable storage medium. The processor of a computer device reads the computer instructions from a computer-readable storage medium, executes the computer instructions, and causes the computer device to perform the methods provided in the various optional implementations mentioned above.

Computer program code for performing the operations in the present disclosure can be written in one or more programming languages or combinations thereof, including object-oriented programming languages such as Java, Smalltalk, C++, or conventional procedural programming languages such as “C” language or similar programming languages. The program code can be completely executed on the user's computer, partially executed on the user's computer, executed as an independent software package, partially executed on the user's computer and partially executed on a remote computer, or completely executed on a remote computer or server. In cases involving remote computers, remote computers can connect to user computers through any type of network, including local area networks (LANs) or wide area networks (WANs), or can connect to external computers (such as using internet service providers to connect via the internet).

The flowchart and block diagram in the attached figures illustrate the possible implementation architecture, functions, and operations of the system, method, and computer program product according to various embodiments of the present disclosure. In this regard, each box in a flowchart or block diagram can represent a portion of a module, program segment, or instruction that contains one or more executable instructions for implementing a specified logical function. It should also be noted that in some alternative implementations, the functions indicated in the box can also occur in a different order than those indicated in the accompanying drawings. For example, two consecutive boxes can be executed in basic parallel, and sometimes they can be executed in opposite order, depending on the functionality involved. It should also be noted that each box in the block diagram and/or flowchart, as well as the combination of boxes in the block diagram and/or flowchart, can be implemented using dedicated hardware based systems that perform specified functions or actions, or can be implemented using a combination of dedicated hardware and computer instructions.

The modules described in the embodiments of the present disclosure can be implemented through software or hardware. Where the name of the module does not constitute a limitation on the module itself in some cases. For example, Module A can also be described as “Module A configured to perform B operations”.

The above description is only a preferred embodiment of the present disclosure and an explanation of the technical principles applied. Those skilled in the art should understand that the scope of the present disclosure referred to in the present disclosure is not limited to technical solutions formed by specific combinations of the above technical features, and should also cover other technical solutions formed by arbitrary combinations of the above technical features or their equivalent features without departing from the above disclosed concept. For example, a technical solution formed by replacing the above features with (but not limited to) technical features with similar functions disclosed in the present disclosure.

1. A communication method, performed by an access point (AP)device, comprising:
determining an Aggregated Physical Layer Protocol Data Unit (A-PPDU);
wherein the A-PPDU comprises one or more sub-PPDUs, and for each of the one or more sub-PPDUs, a physical layer preamble of a respective sub-PPDU comprises bandwidth information, wherein the bandwidth information indicates a transmission bandwidth of the respective sub-PPDU; and
transmitting the A-PPDU.

2. The communication method according to claim 1, wherein the bandwidth information is comprised in a legacy signal (L-SIG) field of the physical layer preamble; and
the L-SIG field further comprises a legacy length (L-length) subfield, wherein the L-length subfield comprises length information of the respective sub-PPDU.

3. The communication method according to claim 1, wherein an SIG field of the respective sub-PPDU comprises at least one of:
basic service set (BSS) color information of the respective sub-PPDU;
a station (STA) identifier corresponding to the respective sub-PPDU;
Modulation and Coding Scheme (MCS) information corresponding to the respective sub-PPDU;
uplink (UL) identifier information or downlink (DL) identifier information corresponding to the A-PPDU;
a Transmission Opportunity (TXOP) subfield, wherein the TXOP subfield comprises length information of the respective sub-PPDU; or
a Padding Value subfield, wherein the Padding Value subfield comprises Padding Value information of the respective sub-PPDU.

4. The communication method according to claim 1, wherein a Media Access Control (MAC) field of the respective sub-PPDU comprises Receiver Address (RA) information and Transmission Address (TA) information;
wherein when the A-PPDU is uplink data, the RA information comprises an MAC address of the AP, and the TA information comprises an MAC address of a STA corresponding to the respective sub-PPDU;
wherein when the A-PPDU is downlink data, the RA information comprises an MAC address of STA corresponding to the respective sub-PPDU, and the TA information comprises an MAC address of the AP.

5. The communication method according to claim 1, wherein
the AP is affiliated with an Access Point Multi-Link Device (AP MLD), and TA information of the AP comprises an MAC address of the AP MLD or an MAC address of a transmission link of the AP MLD;
and/or, p1 a STA is affiliated with a station Multi-Link Device (Non-AP MLD), and RA information of the STA comprises an MAC address of a transmission link of the Non-AP MLD.

6. The communication method according to claim 1, wherein the physical layer preamble comprises a Legacy Long Training Field (L-LTF) and a Legacy Short Training Field (L-STF).

7. A communication method, performed by a station (STA), comprising:
receiving a target sub-PPDU in an Aggregated Physical Layer Protocol Data Unit (A-PPDU);
wherein the A-PPDU comprises one or more sub-PPDUs, and for each of the one or more sub-PPDUs, a physical layer preamble of a respective sub-PPDU comprises bandwidth information, wherein the bandwidth information indicates a transmission bandwidth of the respective sub-PPDU.

8. The communication method according to claim 7, wherein the bandwidth information is comprised in a legacy signal (L-SIG) field of the physical layer preamble; and
the L-SIG field further comprises a legacy length (L-length) subfield, wherein the L-length subfield comprises length information of the respective sub-PPDU.

9. The communication method according to claim 8, wherein the L-SIG field further comprises at least one of:
basic service set (BSS) color information of the respective sub-PPDU;
STA identifier corresponding to the respective sub-PPDU;
Modulation and Coding Scheme (MCS) information corresponding to the respective sub-PPDU;
uplink (UL) identifier information or downlink (DL) identifier information corresponding to the A-PPDU;
a Transmission Opportunity (TXOP) subfield, wherein the TXOP subfield comprises length information of the respective sub-PPDU; or
a Padding Value subfield, wherein the Padding Value subfield comprises Padding Value information of the respective sub-PPDU.

10. The communication method according to claim 7, wherein a Media Access Control (MAC) field of the respective sub-PPDU comprises Receiver Address (RA) information and Transmission Address (TA) information;
wherein when the A-PPDU is uplink data, the RA information comprises an MAC address of an Access Point (AP), and the TA information comprises an MAC address of a STA device corresponding to the respective sub-PPDU;
wherein when the A-PPDU is downlink data, the RA information comprises an MAC address of STA corresponding to the respective sub-PPDU, and the TA information comprises an MAC address of the AP.

11. The communication method according to claim 7, wherein
an AP is affiliated with an Access Point Multi-Link Device (AP MLD), and TA information of the AP comprises an MAC address of the AP MLD or an MAC address of a transmission link of the AP MLD;
and/or,
a STA is affiliated with a station Multi-Link Device (Non-AP MLD), and RA information of the STA comprises an MAC address of a transmission connection of the Non-AP MLD.

12. The communication method according to claim 7, wherein the physical layer preamble comprises a Legacy Long Training Field (L-LTF) and a Legacy Short Training Field (L-STF).

13.-14 (canceled)

15. An electronic device, comprising:
one or more memories that store a computer program; and
one or more processors,
wherein the computer program when collectively executed by the one or more processors, cause the electronic device to act as the AP and perform the method according to claim 1.

16. A non-transitory computer-readable storage medium, storing a computer program the computer program when collectively executed by one or more processors of the AP cause the AP to perform The method according to claim 1.

17. An electronic device, comprising:
one or more memories that store a computer program; and
one or more processors,
wherein the computer program when collectively the one or more processors, cause the electronic device to act as the STA and perform the method according to claim 7.

18. A non-transitory computer-readable storage medium storing a computer program, the computer program when executed by one or more processors of the STA cause the STA to perform the method according to claim 7.
